(19) United States
(12) Patent Application Publication
(10) Pub. No.: US 2005/0262208 A1
(43) Pub. Date: Nov. 24, 2005

(54) System and method for managing emails in an enterprise

(76) Inventors: Eyal Haviv, Tirat Karmel (IL); Doron Shlezinger, Zichron Yakpov (IL); David Daloya, Haifa (IL)

Correspondence Address: FISH & RICHARDSON P.C., 1717 MAIN STREET, SUITE 5000, DALLAS, TX, 75201, US

(21) Appl. No.: 10/869,530

(22) Filed: Jun. 16, 2004

Related U.S. Application Data
(60) Provisional application No. 60/573,157, filed on May 21, 2004.

(51) Int. Cl. G06F 15/16

(52) U.S. Cl. 709/206; 709/224

(57) ABSTRACT

This disclosure provides a system and method for managing emails in an enterprise. In one embodiment, an enterprise email manager is operable to receive a first email to one or more expected recipients. The first email is identified as an adverse email based, at least in part, on one or more of a plurality of enterprise parameters and quarantined. A report email is generated based on the first email, with the report email comprising information identifying the first email and the report email is operable to present dynamic administrative actions associated with the first email. The enterprise email manager then communicates the report email to at least a particular one of the expected recipients.

### RELATED APPLICATION

This application claims the priority under 35 U.S.C. §119 of provisional application Ser. No. 60/573,157 filed May 21, 2004.

### TECHNICAL FIELD

This disclosure generally relates to electronic communications and, more specifically, to a system and method for managing emails in an enterprise.

### BACKGROUND

Electronic mail (or email) generally provides an efficient and timely form of communication for enterprises and other organizations. Indeed, enterprises may send and receive tens of thousands of emails each day. Typically, a number of these received emails are unexpected or unsolicited communications that include, for example, spam and other unsolicited communications, viruses and Trojan horses, and others. These adverse emails cost the enterprise time, money, and resources. In response, most enterprises have some variant of automatic detection such as intrusion detection systems or spam blockers. But these conventional detectors require administrator oversight or management to ensure that valid or non-adverse emails are not quarantined from the expected recipients. For example, the detector may necessitate a system or network administrator manually reviewing each of the (potentially thousands of) identified adverse emails or email senders to determine the propriety.

### SUMMARY

This disclosure provides a system and method for managing emails in an enterprise. In one embodiment, an enterprise email manager is operable to receive a first email to one or more expected recipients. The first email is identified as an adverse email based, at least in part, on one or more of a plurality of enterprise parameters and quarantined. A report email is generated based on the first email, with the report email comprising information identifying the first email and the report email operable to present dynamic administrative actions associated with the first email. The enterprise email manager then communicates the report email to at least a particular one of the expected recipients. The details of one or more embodiments of the invention are set forth in the accompanying drawings and the description below. Particular features, objects, and advantages of the invention will be apparent from the description and drawings and from the claims.

### DESCRIPTION OF DRAWINGS

FIG. 1 illustrates an email management system in accordance with one embodiment of the present disclosure;

FIG. 2 illustrates one embodiment of the enterprise email manager in the system of FIG. 1;

FIG. 3 illustrates one embodiment of the report email generated by the system of FIG. 1;

FIGS. 4A-B are flowcharts illustrating an example method for identifying an adverse email in accordance with one embodiment of the present disclosure;

FIGS. 5A-B are flowcharts illustrating example methods for managing quarantined emails in accordance with one embodiment of the present disclosure; and

FIG. 6 is a flowchart illustrating an example method for processing user commands for quarantined emails in accordance with one embodiment of the present disclosure.

### DETAILED DESCRIPTION

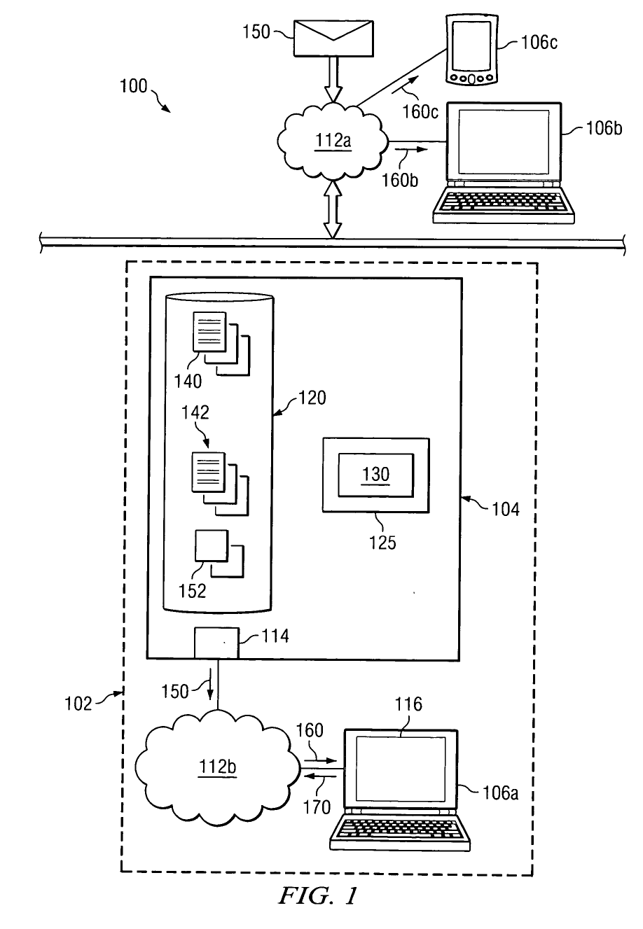

FIG. 1 illustrates an email management system 100 for at least a portion of enterprise 102 in accordance with one embodiment of the present disclosure. Generally, email management system 100 identifies one or more emails 150 to any number of expected recipients as adverse emails 152, generates a report email 160 based on the identified adverse emails 152, and allows the expected recipients to control, manage, or otherwise tailor the analysis via report email 160. Therefore, email management system 100 may avoid or quickly rectify any of the potentially thousands of false-positives identified through the automatic analysis by providing easy review by the expected recipients of the identified adverse email 152. Email management system 100 is typically a distributed client/server system that allows users of clients 106 to review emails 150 and self manage emails 152 automatically identified as adverse by one or more servers 104. For example, system 100 may include server 104 that is connected, through network 112, to one or more local or remote clients 106. But system 100 may be a standalone computing environment or any other suitable environment without departing from the scope of this disclosure. In short, system 100 includes at least a portion of enterprise 102, which includes or is associated with at least one server 104, which is operable to receive or process one or more emails 150. The term “dynamically,” as used herein, generally means that certain processing is determined, at least in part, at run-time based on one or more variables. The term “automatically,” as used herein, generally means that the appropriate processing is substantially performed by at least part of email management system 100. It should be understood that “automatically” further contemplates any suitable user or administrator interaction with system 100 without departing from the scope of this disclosure.

Server 104 includes memory 120 and processor 125 and comprises an electronic computing device operable to receive, transmit, process and store data associated with system 100. For example, server 104 may be any computer or processing device such as, for example, a blade server, general-purpose personal computer (PC), Macintosh, workstation, Unix-based computer, or any other suitable device. Generally, FIG. 1 provides merely one example of computers that may be used with the disclosure. For example, although FIG. 1 illustrates one server 104 that may be used with the disclosure, system 100 can be implemented using computers other than servers, as well as a server pool. In other words, the present disclosure contemplates computers other than general purpose computers as well as computers without conventional operating systems. As used in this document, the term “computer” is intended to encompass a personal computer, workstation, network computer, or any other suitable processing device. Server 104 may be adapted to execute any operating system including Linux, UNIX, Windows Server, or any other suitable operating system. According to one embodiment, server 104 may also include or be communicably coupled with a web server and/or a mail server.

Memory 120 may include any memory or database module and may take the form of volatile or non-volatile memory including, without limitation, magnetic media, optical media, random access memory (RAM), read-only memory (ROM), removable media, or any other suitable local or remote memory component. In this embodiment, illustrated memory 120 includes user parameters 140 and enterprise parameters 142, but may also include any other appropriate data such as a quarantine repository of adverse emails 152, an audit log, black and white lists or other content policies, and/or virus signatures.

User parameters 140 include any parameters, variables, policies, algorithms, or rules for user-managed quarantine processing. For example, user parameters 140 may allow expected recipients to easily customize or override adverse processing by server 104. In one embodiment, user parameters 140 may comprise one or more tables stored in a relational database described in terms of SQL statements or scripts. In another embodiment, user parameters 140 may store or define various data structures as text files, eXtensible Markup Language (XML) documents, Virtual Storage Access Method (VSAM) files, flat files, Btrieve files, comma-separated-value (CSV) files, internal variables, or one or more libraries. In short, user parameters 140 may comprise one table or file or a plurality of tables or files stored on one computer or across a plurality of computers in any appropriate format. Moreover, user parameters 140 may be local or remote without departing from the scope of this disclosure and store any type of appropriate data. For example, user parameters 140 may store a plurality of individual recipient/user policies including: i) identifying an email address as spam/not spam; ii) identifying an email domain as spam/not spam; iii) identifying an IP address as spam/not spam; iv) identifying email content as spam/not spam; v) identifying an email attachment as spam/not spam and any other appropriate user-managed parameter.

Enterprise parameters 142 includes any parameters for identifying adverse emails 152 based on enterprise-wide considerations. For example, enterprise 102 may generate enterprise parameters 142 that may not allow or desire personal or non-business emails 150 to be received during business hours. In another example, enterprise 102 may generate enterprise parameters 142 to attempt to block pornographic emails 152 at any time. As with user parameters 140, in one embodiment enterprise parameters 142 may comprise one or more tables stored in a relational database described in terms of SQL statements or scripts. In another embodiment, enterprise parameters 142 may store or define various data structures as XML documents, VSAM files, flat files, Btrieve files, CSV files, internal variables, or one or more libraries. In short, enterprise parameters 142 may comprise one table or file or a plurality of tables or files stored on one computer or across a plurality of computers in any appropriate format. Moreover, enterprise parameters 142 may be local or remote without departing from the scope of this disclosure and store any type of appropriate data. For example, enterprise parameters 142 may store enterprise-wide policies including: i) an enterprise white list; ii) an enterprise blacklist; iii) a real-time blacklist; iv) adverse content policies and other spam detection; and v) antivirus policies. It will be understood that user parameters 140 and enterprise parameters 142 may be stored or referenced in one table, file, data structure, or repository without departing from the scope of this disclosure.

Server 104 also includes processor 125. Processor 125 executes instructions and manipulates data to perform the operations of server 104 such as, for example, a central processing unit (CPU), a blade, an application specific integrated circuit (ASIC), or a field-programmable gate array (FPGA). Although FIG. 1 illustrates a single processor 125 in server 104, multiple processors 125 may be used according to particular needs and reference to processor 125 is meant to include multiple processors 125 where applicable. In the illustrated embodiment, processor 125 executes enterprise email manager 130, which performs at least a portion of the analysis of incoming emails 150 and allows users to at least partially customize the analysis through user parameters 140.

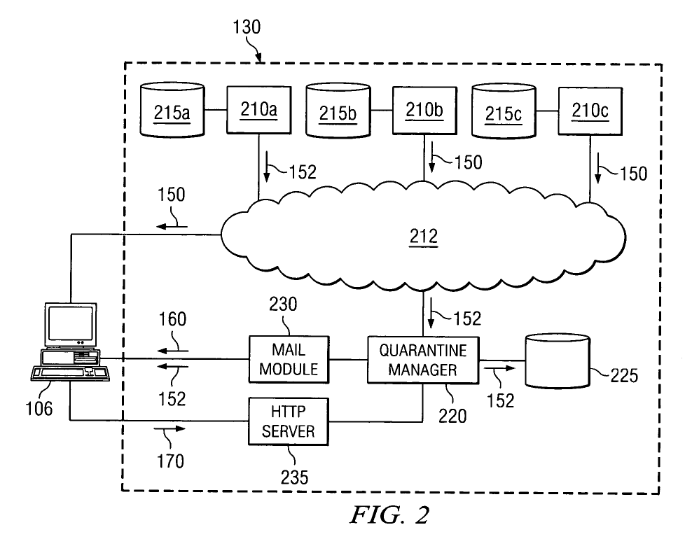

Enterprise email manager 130 could include any hardware, software, firmware, or combination thereof operable to automatically process emails 150 and dynamically respond to user commands 170 involving potentially adverse emails 152. For example, enterprise email manager 130 may be written or described in any appropriate computer language including C, C++, Java, Visual Basic, assembler, any suitable version of 4GL, and others or any combination thereof. It will be understood that while enterprise email manager 130 is illustrated in FIG. 1 as a single multi-tasked module, the features and functionality performed by this engine may be performed by multiple modules such as, for example, a quarantine manager, an HTTP server, one or more spam engines, and a quarantine repository (as shown in more detail in FIG. 2). Further, while illustrated as internal to server 104, one or more processes associated with enterprise email manager 130 may be stored, referenced, or executed remotely. Moreover, enterprise email manager 130 may be a child or sub-module of another software module (not illustrated) without departing from the scope of this disclosure. In one embodiment, enterprise email manager 130 may include or be communicably coupled with an administrative workstation or graphical user interface (GUI). This administrative GUI may provide the administrator with the ability to: i) view the folder content that exists within each user's quarantine folder; ii) delete/release messages from a user quarantine folder; iii) configure the type of report email 160 such as in-line or attachment; iv) configure an expiration period for quarantined messages 152 in the queue and an associated action upon expiration, such as delete or release; and/or v) configure the timing of report email 160 creation such as, for example, generation of email report 160 based on a number of quarantine emails 152 compared with a configured value, a predetermined timeframe, or in response to a request a the expected recipient. Another or the same GUI may allow one or more of the expected recipients to view email content. It will be understood that the administration GUI may provide none, some, or all of these example abilities, as well as other abilities, without departing from the scope of this disclosure.

Server 104 may also include interface 114 for communicating with other computer systems, such as client 106, over network 112 in a client-server or other distributed environment. In certain embodiments, server 104 receives emails 150 from internal or external senders through interface 114 for storage in memory 120 and/or processing by processor 125. Generally, interface 114 comprises logic encoded in software and/or hardware in a suitable combination and operable to communicate with network 112. More specifically, interface 114 may comprise software supporting one or more communications protocols associated with communications network 112 or hardware operable to communicate physical signals.

Network 112 facilitates wireless or wireline communication between computer server 104 and any other local or remote computer, such as clients 106. Indeed, while illustrated as two networks, external 112a and internal 112b respectively, network 112 may be a continuous network without departing from the scope of this disclosure, so long as at least portion of network 112 may facilitate communications between senders and recipients of emails 150. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

Client 106 is any local or remote computing device operable to present the user with a report email 160 and receive user commands 170 via a GUI 116. At a high level, each client 106 includes at least GUI 116 and comprises an electronic computing device operable to receive, transmit, process and store any appropriate data associated with system 100. It will be understood that there may be any number of clients 106 communicably coupled to server 104. For example, illustrated clients 106 include one local client 106 and two clients external to the illustrated portion of enterprise 102. Further, “client 106,” “recipient,” and “user” may be used interchangeably as appropriate without departing from the scope of this disclosure. Indeed, each user may have multiple email addresses or, in other words, be a number of recipients. In this example, enterprise email manager 130 may use LDAP requests to resolve the user's primary account, thereby recognizing several aliases as the same user and generating one email report 160 for the various aliases. Moreover, for ease of illustration, each client 106 is described in terms of being used by one user. But this disclosure contemplates that many users may use one computer or that one user may use multiple computers to receive or review emails 150, 152, and 160 via GUI 116. As used in this disclosure, client 106 is intended to encompass a personal computer, touch screen terminal, workstation, network computer, kiosk, wireless data port, wireless or wireline phone, personal data assistant (PDA), one or more processors within these or other devices, or any other suitable processing device. For example, client 106 may comprise a computer that includes an input device, such as a keypad, touch screen, mouse, or other device that can accept information, and an output device that conveys information associated with the operation of server 104 or clients 106, including digital data, visual information, or GUI 116. Both the input device and output device may include fixed or removable storage media such as a magnetic computer disk, CD-ROM, or other suitable media to both receive input from and provide output to users of clients 106 through the display, namely GUI 116.

GUI 116 comprises a graphical user interface operable to allow the user of client 106 to interface with at least a portion of system 100 for any suitable purpose. Generally, GUI 116 provides the user of client 106 with an efficient and user-friendly presentation of data provided by or communicated within system 100. In certain embodiments, GUI 116 is RFC-compliant with HTTP Post commands. GUI 116 may comprise a plurality of customizable frames or views having interactive fields, pull-down lists, and buttons operated by the user. In one embodiment, GUI 116 presents report email 160 that includes the various quarantine email information and associated buttons and receives commands 170 from the user of client 106 via one of the input devices. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information in system 100 and efficiently presents the results to the user. Server 104 can accept data from client 106 via the web browser (e.g., Microsoft Internet Explorer or Netscape Navigator) and return the appropriate HTML or XML responses using network 112.

In one aspect of operation, enterprise 102 receives one or more emails 150 via network 112. Generally, emails 150 are communicated from external mail servers. But this disclosure contemplates that emails 150 may be received from other divisions or portions of enterprise 102. Server 104 receives or retrieves emails 150 for processing by enterprise email manager 130, which determines if any of emails 150 include adverse content, viruses, spam, or any other deleterious or wasteful data. If enterprise email manager 130 determines that one of the emails 150 is an adverse email 152, then manager 130 quarantines email 152 in any appropriate repository, such as memory 120. At any appropriate time during this processing, enterprise email manager 130 generates a report email 160 to each of the expected recipients of the quarantined emails 152, such as at a configured time, if the number of quarantined emails 152 for the recipient exceeds a threshold, or in response to a request from client 106. For example, report email 160 may reflect, reference, or present the particular user's quarantine folder status. Using report email 160, the user may then select individual actions associated with each quarantined email 152 or a global action for all referenced emails 152. These selections are automatically gathered and communicated via one or more commands 170.

Once the user submits the appropriate command 170 including the one or more selected actions, client 106 automatically creates a buffer containing or representing command 170 in response to the appropriate HTML action. This buffer is automatically communicated to enterprise email manager 130 or an associated HTTP server by GUI 116, as instructed by the “POST” command the HTTP protocol. For example, one command 170 may include a URL of manager 130 or the HTTP server such as <FORM action=“http://130.119.183.19:8080/” method=post>. But this disclosure contemplates any appropriate technique or technology for creating, communicating, or identifying user commands 170. For example, rather than (or in addition to) using the standard “HTTP Form POST” command, system 100 may use the “HTTP Form GET” action or a Java script embedded within or referenced by report email 160, which gathers the user form data and creates the stream buffer. In another example, system 100 may use HTML <FORM> action—“mailto:”. In this example, GUI 116 generates the same FORM data structure as in the POST action and generates an email with the data structure inside. It will be understood that system 100 may use none, some, or all of the example technologies (as well as others), individually or in combination, to return user commands 170 from the user to enterprise email manager 130. Returning to the example “POST” embodiment, enterprise email manager 130 or the HTTP proxy server is typically actively listening for commands 170. Once the URL or buffer has been identified and verified, enterprise email manager 130 gathers the buffer for processing. At any time, an HTML notification page, notification email, or other communication is sent back to the user acknowledging that command 170 was received and will be processed. Enterprise email manager 130 then parses or dissembles this buffer, identifies each one of the user's commands 170 or actions, and implements them accordingly. In certain embodiments, enterprise email manager 130 automatically modifies, adds or deletes one or more user parameters 140 based on the associated actions. For example, if the expected recipient determines that adverse email 152 is not spam, then manager 130 may generate or modify a user parameter 140 operable to identify subsequent similar emails 150 as proper communications.

FIG. 2 illustrates one embodiment of enterprise email manager 130 in email management system 100. This embodiment of enterprise email manager 130 illustrates various processes distributed among a number of sub-modules, namely a plurality of scanning engines 210, quarantine manager 220, mail module 230, and HTTP server 235. As described above, each sub-module may be a library, function, service, method, or object written or described in any appropriate computer language including C, C++, Java, Visual Basic, assembler, any suitable version of 4GL, and others or any combination thereof. Further, each sub-module may be local or remote so long it remains communicably coupled with other appropriate sub-modules and components.

Scanning engines 210 comprise or implement any suitable analysis algorithm to process emails 150 to determine whether it is of an adverse nature. For example, scanning engine 210 may use algorithms, signatures, scripts, or any suitable detection or comparison technique to process emails 150, attachments, and/or any other associated incoming data. Once identified, scanning engine 210 may communicate adverse emails 152 to quarantine manager 220 individually or in bulk. Further, scanning engine 210 may compress the one or more emails 152 prior to communication to quarantine manager 220, thereby reducing utilized bandwidth and increasing efficiency. It will be understood that while scanning engine 210 is illustrated as a single multi-tasked module, the features and functionality performed by this engine may be performed by multiple modules such as for example, a sensor module and a packet flow generation module. In one embodiment, illustrated scanning engines 210 represent various modules or processes of one scanning engine, each operable to monitor one of a plurality of communication ports. In other words, each scanning engine 210 is any component operable to identify adverse emails 152 and communicate each email 152 to quarantine manager 220. In the illustrated embodiment, scanning engine 210 is associated with local memory 215. Associated memory 215 is any object, data structure, memory, or database operable to store local versions of at least a portion of user parameters 140 and/or enterprise parameters 142.

Quarantine manager 220 is one or more methods, modules, libraries, objects, services, or combination thereof that processes adverse emails 152 received from one of the scanning engines 210, such that emails 152 are quarantined in quarantine repository 225 using any suitable technique. In one embodiment, once quarantine manager 220 receives emails 152 from one of the scanning engines 210, it copies each quarantined object and its associated data file into each expected recipient's quarantine folder. Quarantine manager 220 may receive one or more emails 152 from scanning engines 210 in compressed and/or encrypted format and automatically uncompress and/or decrypt the compressed communication. At a high level, quarantine manager 220 is operable to perform any appropriate quarantine processing of adverse emails 152 such as, for example, generate report emails 160 to the expected recipients of adverse emails 152, execute user submission requests or commands 170 via, for example, the submit buffer sent from HTTP server 235, release or delete quarantined emails 152 upon expiration or command, and/or maintain user parameters 140 and propagate any changes to user parameters 140 to any of the scanning engines 210 for storage in associated memory 215.

In one embodiment, quarantine manager 220 includes or implements an HTML builder and/or an email builder. The HTML builder is operable to create an HTML page from an identified quarantined emails 152. For example, the HTML builder generates an HTML form or page that includes the information used for helping the user to decide appropriate actions for each of the quarantine emails 152. The email builder is operable to generate report email 160, which may have several Multipurpose Internet Mail Extension (MIME) parts in it. For example, if quarantine manger 220 determines that the recipient is to receive an inline report email 160, the email builder may generate two MIME parts: i) a text MIME component with a message; and ii) an HTML MIME component with the HTML form in it. In another example, if quarantine manger 220 determines that the recipient is to receive an attached report email 160, email builder may alternatively generate two MIME parts: i) a text MIME part with any message for the user; and ii) a file attachment part with the HTML page as attachment for the user to open. Accordingly, quarantine manager 220 or email builder may also generate a Simple Mail Transfer Protocol (STMP) header for report email 160 for sending the email through SMTP protocol according to RFC822.

Quarantine manager 220 may also include or implement a parse command unit. Generally, the parse command unit receives the submit data buffer for command 170 and dissembles or parses it. Parse command unit may create an items list from the buffer for performing or otherwise executing the various actions by quarantine manager 220. For example, one parsed submit data buffer may follow the following format:

StartDataFile=
&EMAIL_ACTION1=130.119.183.13--00--emailfile001010100.eml--
00--Release
&EMAIL_ACTION2=130.119.183.13--00--emailfile001010330.eml--
00--Delete
&EMAIL_ACTION3=130.119.183.13--00--emailfile001012200.eml--
00--Leave
&EMAIL_ACTION4=130.119.183.13--00--emailfile001011100.eml--
00--Not_Spam
&GLOBAL_ANSWER=Submit
&RepType=White_List
&RepVer=1.0.0.1
&ReportOwnerName=David@ca.com
&EndDataFile=

where StartDataFile marks the start of the submission data, RepType is the type of the report, RepVer is the version of the report, ReportOwnerName is the name, email address, or other identifier of the recipient or user that received report email 160, and EndDataFile marks the end of the submission data. Further, EMAIL_ACTIONxx may represent one item (or email 152) that exists or is presented in report email 160. The example above contains four settings for four emails. In each email action, there are often tree values that are separated by a delimiter (i.e., --0--). The first value is an IP address and the second value is a file name for finding the specific email 152 in quarantine repository 225. But any appropriate locator or identifier may be used. The third value is the selected associated action for this item (for example, Release/Delete/Leave/Not_Spam). GLOBAL_ANSWER provides the user with the ability to set “Release all,” “Delete all,” or “Leave all,” thereby avoiding the end user from having to individually specify an associated action for each item. If the global answer parameter differs from “Submit” (which submits the individual actions), then the global user-managed action (or the specific value) overwrites all individual user-managed actions in the specific submission data. It will be understood that the forgoing example is for illustration purposes only and command 170 or the associated buffer may comprise any format and include any appropriate data for allowing the user to manage quarantined emails 152 and user parameters 140. It will be understood that example HTML builder, email builder, and parse command unit modules are for illustrative purposes only and the described functionality associated with each may be executed within the same module or sub-module without departing from the scope of this disclosure.

Quarantine manager 220 may include or be communicably coupled with a quarantine manager database 225, possibly stored in memory 120. Quarantine manager database 225 is any repository and may comprise one or more XML tables or documents. The various elements may also be described in terms of SQL statements or scripts, VSAM files, flat files, binary data files, Btrieve files, database files, or CSV files. It will be understood that each element may comprise a variable, table, or any other suitable data structure. Quarantine manager database 225 may also comprise a plurality of tables or files stored on one server 104 or across a plurality of computers. In one embodiment, quarantine manager 220 may use the user's email address to build a file system path for the objects, using the following syntax:

{Installation Directory}\Quarantine\{ User's Email Domain
Name}\{User's Email Address First Letter}\{Full
User's Email Address local part}\{Scan Engine IP in
numerical format}\{Actual Object Name}

In case of an email with multiple recipients, quarantine manager 220 may generate a separate copy in one folder for each user that needs the object to be quarantined.

Generally, mail module 230 is an example module for distributing report email 160 to particular users or recipients. Once report email 160 was generated by quarantine manager 220, it is dropped (often along with an associated data file) into a directory that is hooked by mail module 230. At any appropriate time after that (such as near immediate or based on a predetermined time), mail module 230 communicates report email 160 to one or more identified recipients or a destination based on input placed within the data file.

HTTP server 235 comprises any module, library, or service operable to trap one or more commands 170, including user form data, from one of the recipients of report email 160. In one embodiment, GUI 116 posts commands 170 in a stream buffer. For example, HTTP server 235 may listen on port 8080 for HTTP “POST” commands 170. When a POST command is received, HTTP server 235 collects the HTTP buffer, including the user submit actions, and validates this buffer is valid. Once validated, HTTP server 235 communicates the buffer to quarantine manager 220. This disclosure contemplates any appropriate technique or technology for creating, communicating, or identifying user commands 170. For example, rather than using standard “HTTP Form POST” command, system 100 may use the “HTTP Form GET” action. When using the HTML Form submission with the “HTTP Form GET” action, the browser will attach the user form stream data into the URL. In another example, system 100 may use a Java script, embedded within or referenced by report email 160, which gathers the user form data and creates the stream buffer.

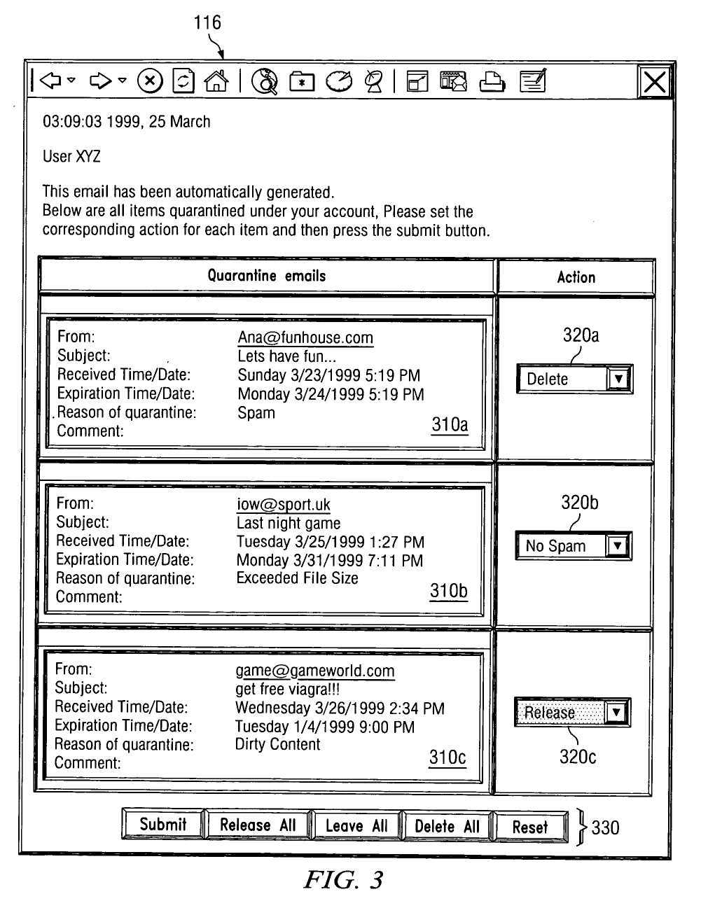

FIG. 3 illustrates one embodiment of report email 160 generated by email management system 100 in response to identifying one or more adverse emails 152. As described above, report email 160 provides an expected recipient with a summary of adverse emails 152 and various actions that may be automatically performed in response to selection by the recipient. In one embodiment, report email 160 presents information for each quarantined email 152, a plurality of available individual actions for each email 152, and global actions. For example, illustrated report email 160 includes three information frames 310a, b, and c, each associated with one adverse email 152 in which the user is an expected recipient. Each information frame 310 is associated with a drop-down list 320 including a plurality of individual actions. Drop-down list 320 may present any appropriate user-managed action including “release,” “delete,” “leave,” “not spam,” and others. Drop-down list 320 may present any appropriate user-managed action and may be any appropriate graphical element including radio buttons, hyperlinks, a menu, and others. Illustrated report email 160 further includes global action buttons 330 that override or submit the individual action selections. Any suitable global user-managed actions may be presented including “submit,” “release all,” “leave all,” “delete all,” “reset,” and others. Global action buttons 330 may be any appropriate graphical elements including radio buttons, hyperlinks, a menu, and others. Generally, report email 160 is communicated to an individual user and includes information for all adverse emails 152 quarantined for the particular user. But report email 160 may be communicated to any number of users so long as each user is presented with the appropriate information. It will be understood that FIG. 3 illustrates merely an example report email 160 and email management system 100 may generate, utilize, communicate, or present any format, version, or layout of report email 160 with any appropriate text or graphical elements so long as report email 160 remains appropriate.

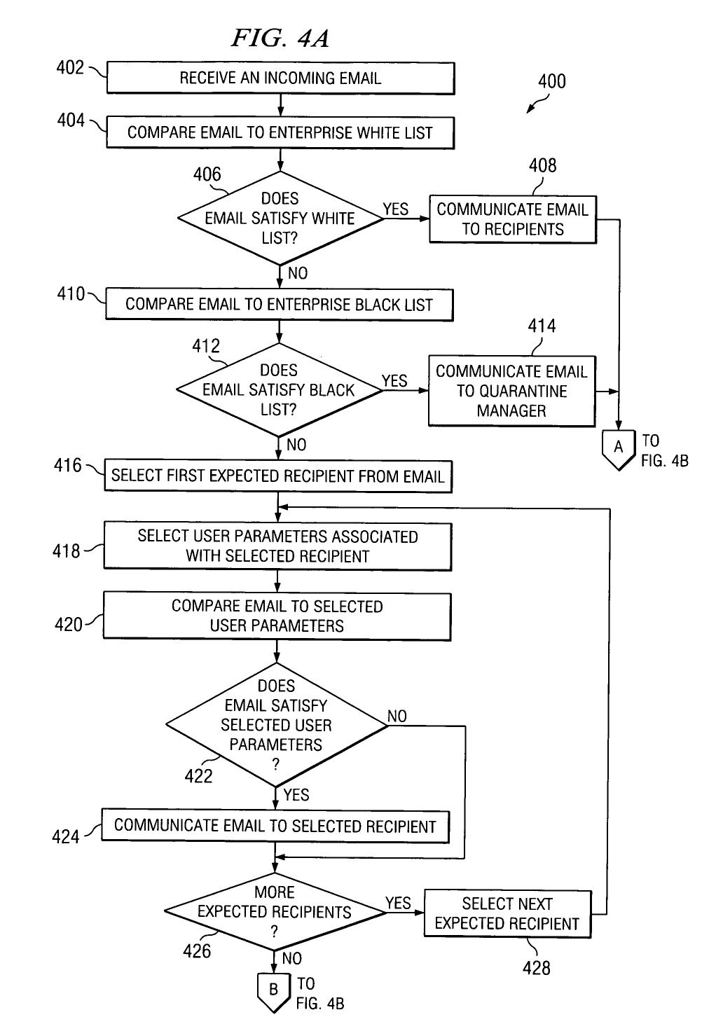

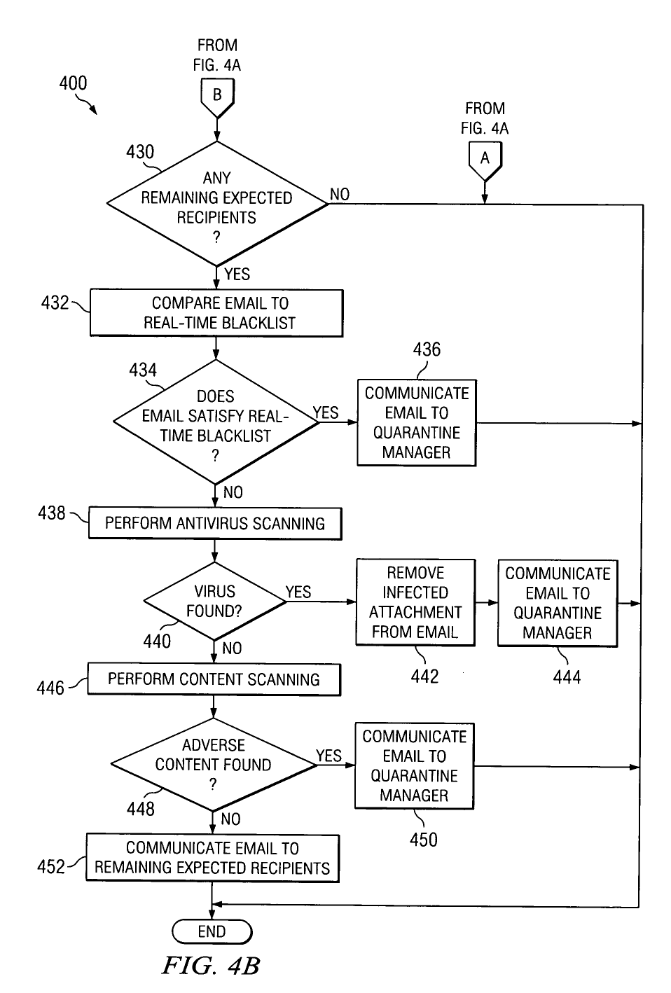

FIGS. 4A-B are flowcharts illustrating an example method 400 for identifying an adverse email 152 in accordance with one embodiment of the present disclosure. At a high level, method 400 includes receiving an incoming email 150, determining whether email 150 is an adverse email 152 based on any of a plurality of characteristics and communicating email 150 to one or more the expected recipients if not adverse. The following description focuses on the operation of enterprise email manager 130 in performing method 400. But system 100 contemplates using any appropriate combination and arrangement of logical elements implementing some or all of the described functionality.

Method 400 begins at step 402, when scanning engine 210 receives an incoming email 150. Next, scanning engine 210 compares email 150 to any enterprise parameter 142, such as an enterprise white list stored in associated memory 215, at step 404. It will be understood that this comparison may be performed using any suitable technique or based on any appropriate characteristic, such as, for example, domain name, IP address, and others. If email 150 satisfies the enterprise white list at decisional step 406, then scanning engine 210 communicates email 150 to the one or more recipients at step 408 and processing of incoming email 150 ends. In one embodiment, scanning engine 210 may communicate email 150 directly to the recipients. In another embodiment, scanning engine 210 may communicate email 150 to the recipients via mail module 230. If email 150 does not satisfy the white list, then scanning engine 210 next compares email 150 to an enterprise black list or other enterprise parameter 142, such as that stored in associated memory 215, at step 410. If email 150 satisfies the enterprise black list at decisional step 412, then scanning engine 210 identifies email 150 as an adverse email 152 and communicates email 152 to quarantine manager 220 at step 414 and adverse processing ends.

If email 150 does not satisfy enterprise parameters 142, such as the white list and the black list, then scanning engine 210 selects a first expected recipient from email 150 at step 416. Next, at step 418, scanning engine 210 selects user parameters 140 associated with the selected recipient. Scanning engine 210 then compares email 150 to the selected user parameters 140 at step 420. If email 150 satisfies the selected user parameters 140 at decisional step 422, then scanning engine 210 communicates email 150 to the selected recipient at step 424. Accordingly, scanning engine 210 may no longer identify the selected recipient as an expected recipient. Regardless, scanning engine 210 determines if there are remaining expected recipients for an email 150 at decisional step 426. If there are more expected recipients, then scanning engine 210 selects the next expected recipient at step 428 and processing returns to step 418. Scanning engine 210 then determines if there are any remaining expected recipients at decisional step 430. In other words, scanning engine 210 determines if all the expected recipients have received email 150 based on the associated user parameters. If there are no remaining expected recipients after comparison with appropriate user parameters 140, then adverse processing ends.

Otherwise, at step 432, scanning engine 210 compares email 150 to a real-time black list (RBL). If email 150 satisfies the RBL at decisional step 434, then scanning engine 210 identifies email 150 as adverse email 152 and communicates email 152 to quarantine manager 220 at step 436. If email 150 is not adverse email 152, then scanning engine 210 next performs antivirus scanning at step 438. If scanning engine 210 determines that email 150 has a virus, Trojan horse, worm, or an infected attachment at decisional step 440, then scanning engine 210 may perform any appropriate antivirus functions. For example, at step 442, scanning engine 210 removes the infected attachment (if one exists) from identified adverse email 152. Once disinfected, scanning engine 210 then communicates adverse email 152 to quarantine manager 220 at step 444 and processing ends. In another example, scanning engine 210 disinfects email 152 and communicates the disinfected email to the expected recipients after adverse content processing. Continuing the other example, if scanning engine 210 is unable to disinfect adverse email 152, then scanning engine 210 quarantines email 152 through quarantine manager 220. If no virus is found, the scanning engine 210 performs content scanning based on any appropriate content policies at step 446. For example, scanning engine 210 may attempt to identify pornography, spam, scams, or other unsolicited or unwanted communications. If adverse content is found at decisional step 448, then scanning engine 210 identifies email 150 as adverse email 152 and communicates email 152 to quarantine manager 220 and method 400 ends. If no adverse content is found in email 150, scanning engine 210 communicates email 150 to any remaining expected recipients at step 452. As described above, scanning engine 210 may directly communicate email 150 to the remaining recipients or may communicate email 150 to a mail server, such as mail module 230 or an SMTP engine, for subsequent communication.

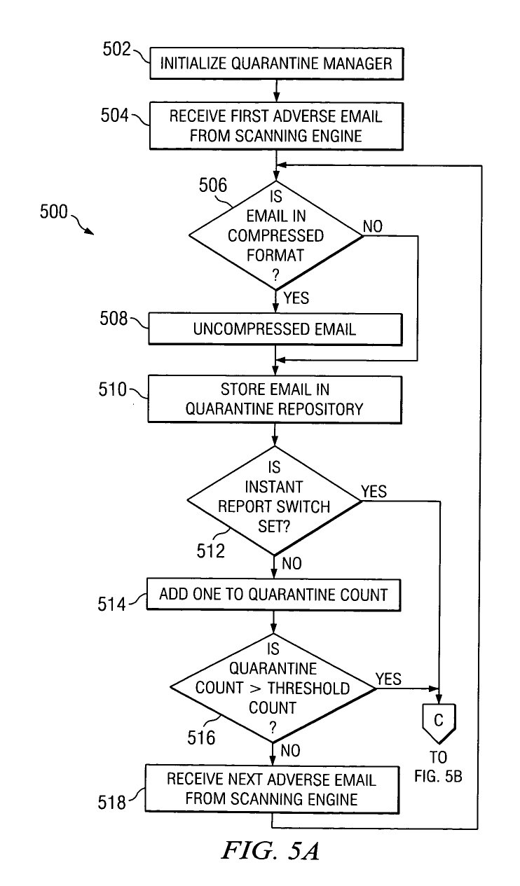

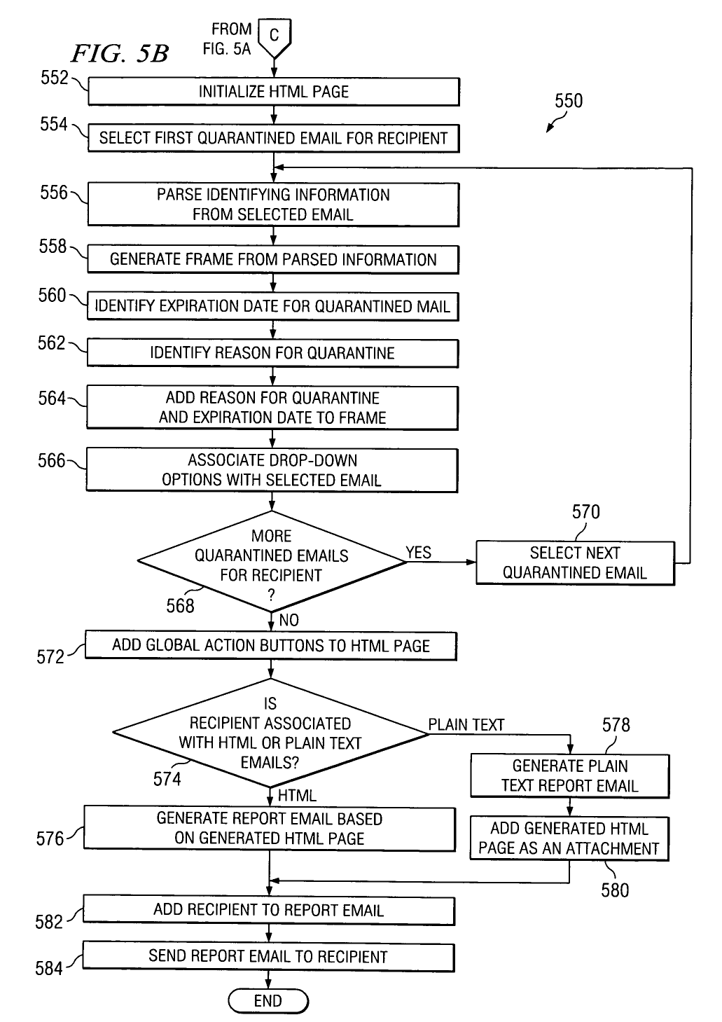

FIGS. 5A-B are flowcharts illustrating example methods 500 and 550, respectively, for managing quarantined emails in accordance with one embodiment of the present disclosure. Generally, method 500 describes one example technique for enterprise email manager 130 to identify an appropriate time for generating and communicating report email 160 and method 550 describes an example technique for generating report email 160. It will be understood that methods 500 and 550 are for illustration purposes only and these or similar techniques may be performed at any appropriate time, including concurrently, individually, or in combination. The following descriptions will focus on the operation of enterprise email manager 130 in performing this method. But, as with the previous flowchart, system 100 contemplates using any appropriate combination and arrangement of logical elements implementing some or all of the described functionality.

Method 500 begins at step 502, where quarantine manager 220 is initialized. It will be understood that this initialization may occur at any appropriate time such as, for example, at system start-up or boot, at a predetermined time, or any other appropriate time. Further, this initialization may involve resetting various parameters in quarantine manager 220 including a quarantine count. Next, at step 504, quarantine manager 220 receives a first adverse email 152 from one of the plurality of scanning engines 210. Quarantine manager 220 then determines if email 152 is in compressed or other similar format at decisional step 506. If email 152 is compressed, then quarantine manager 220 uncompresses adverse email 152 at step 508. Once ready, quarantine manager 220 stores first adverse email 152 in quarantine repository 225 at step 510. Once email 152 has been suitably quarantined, then quarantine manager 220 identifies when to generate and communicate report email 160 in steps 512 through 518.

At decisional step 512, quarantine manager 220 determines if an instant report switch, parameter, or other variable is set, and if so, then processing proceeds to FIG. 5B. If the instant report switch is not set, then quarantine manager 220 adds one to the quarantine count at step 514. Next, quarantine manager 220 compares the quarantine count to a predetermined threshold count to determine if the quarantine count is greater than the threshold count at decisional step 516. If the quarantine count is greater, then processing proceeds to FIG. 5B. Otherwise, quarantine manager 220 receives a next adverse email 152 from one of the plurality of scanning engines 210 at step 518 and processing returns to step 506. It will be understand that while illustrated as an endless loop, the steps in method 500 may occur serially or in parallel, as well as dynamically based on receiving adverse email 152.

Once quarantine manager 220 determines that a report email 160 should be generated, quarantine manager 220 executes example method 550. For example, quarantine manager 220 initializes an HTML page at step 552. Next, at step 554, quarantine manager 220 selects first quarantine email 152 from quarantine repository 225 for a particular recipient. Quarantine manager 220 then parses identifying information for the selected email 152 at step 556. At least partially based on this parsed information, quarantine manager 220 generates a frame for embedding in the initialized HTML page. Next, quarantine manager 220 identifies an expiration date for the selected quarantine email 152. It will be understood that this expiration date may be dynamically determined or predetermined based upon an administrative parameter. At step 562, quarantine manager 220 identifies the reason for the quarantine. For example, email 152 may be identified as adverse and quarantined because it contained a virus, adverse content, or for any other suitable reason. Once identified, quarantine manager 220 adds the reason for the quarantine and the expiration date to the generated frame at step 564. Quarantine manager 220 then associates an appropriate drop-down list 320 with the generated frame 310 at step 566. Next, quarantine manager 220 determines if there are more quarantine emails 152 for the particular recipient at decisional step 568. If there are more quarantine emails 152, then quarantine manager 220 selects the next quarantine email 152 at step 570 and processing returns to step 556.

Once there are no more quarantine emails 152, then quarantine manager 220 adds global action buttons 330 to the initialized HTML page at step 572. It will be understood that global action buttons 330 may be written in Java, HTML, C++, or any other appropriate language. Next, quarantine manager 220 determines if the particular recipient is associated with HTML or plain text emails at decisional step 574. It will be understood that HTML and plain text are for example purposes only and any appropriate format or language may be used to generate or present report email 160. Further, quarantine manager 220 may determine that the recipient is associated with a particular format of email 160 dynamically based on a policy, predetermined based on administrative parameters, or through any other suitable technique. If the particular recipient is to receive an HTML email, then quarantine manager 220 generates report email 160 based on the generated HTML page at step 576. If the user is to receive a plain text email, then quarantine manager 220 generates a plain text report email 160 at step 578. Next, quarantine manager 220 adds the generated HTML page as an attachment to the plain text report email 160 at step 580. Once report email 160 has been appropriately generated, quarantine manager 220 adds the particular recipients to the report email at step 582 and communicates report email 160 using any appropriate mailing or communication technique at step 584.

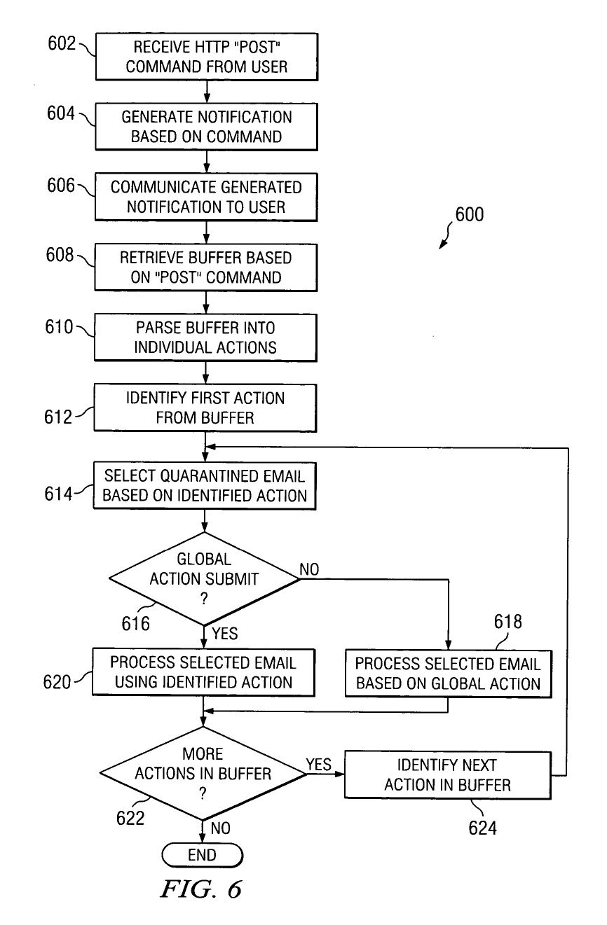

FIG. 6 is a flowchart illustrating an example method 600 for processing user commands for quarantined emails in accordance with one embodiment of the present disclosure. At a high level, method 600 describes receiving and processing user commands 170 for customizing the analysis by enterprise email manager 130 using report email 160. The following description will focus on the operation of enterprise email manager 130 in performing this method. But, as with the previous flowcharts, system 100 contemplates using any appropriate combination and arrangement of logical elements implementing some or all of the described functionality.

Method 600 begins at step 602, when enterprise email manager 130 receives an HTTP post command 170 from a user. As described above, HTTP post command 170 may be an HTTP get command or a Java script without departing from the scope of this disclosure. Next, enterprise email manager 130 automatically generates a notification based on the received command 170 at step 604. For example, enterprise email manager 130 may generate an HTML confirmation page. In another example, enterprise email manager 130 may generate a notification email. At step 606, enterprise email manager 130 communicates the generated notification to the particular user. Returning to the example, enterprise email manager 130 may communicate the HTML confirmation page to GUI 116 for viewing by the user. Next, enterprise email manager 130 retrieves a buffer based on the received post command 170 at step 608. Enterprise email manager 130 then parses the retrieved buffer into one or more individual actions at step 610. Once parsed, enterprise email manager 130 identifies and processes actions within the buffer in steps 612 through 624.

At step 612, enterprise email manager 130 identifies the first action from the parsed buffer. Next, enterprise email manager 130 selects quarantine email 152 from quarantine repository 225 based on the identified action at buffer at step 614. Enterprise email manager 130 then determines if the global action in the parsed buffer is “submit” at decisional step 616. If the global action is not “submit,” then enterprise email manager 130 processes the selected email 152 based on the global action. Otherwise, enterprise email manager 130 processes the selected email 152 using the identified action associated with quarantine email 152 at step 620. Once quarantine email 152 has been processed based on the appropriate action, enterprise email manager 130 determines if there are more actions in the buffer at decisional step 522. If there are, then enterprise email manager 130 identifies the next action in the buffer and processing returns to step 614. Once all the actions in the buffer have been processed, processing of this particular user command 170 ends.

The preceding flowcharts and accompanying description illustrate exemplary methods 400, 500, 550, and 600. In short, system 100 contemplates using any suitable technique for performing these and other tasks. Accordingly, many of the steps in these flowcharts may take place simultaneously and/or in different orders than as shown. Moreover, system 100 may use methods with additional steps, fewer steps, and/or different steps, so long as the methods remain appropriate.

Although this disclosure has been described in terms of certain embodiments and generally associated methods, alterations, and permutations of these embodiments and methods will be apparent to those skilled in the art. For example, enterprise email manager 130 may generate a report email 160 that includes a URL to a secure server operable to store and present the generated HTML page to the user after credentials verification. Accordingly, the above description of example embodiments does not define or constrain this disclosure. Other changes, substitutions, and alterations are also possible without departing from the spirit and scope of this disclosure.

1. An enterprise email manager operable to:
receive a first email to one or more expected recipients;
identify the first email as an adverse email based, at least in part, on one or more of a plurality of enterprise parameters;
quarantine the first email;
generate a report email based on the first email, the report email comprising information identifying the first email and the report email operable to present dynamic user-managed actions associated with the first email; and
communicate the report email to at least a particular one of the expected recipients.

2. The enterprise email of claim 1, the user-managed actions comprising at least one of the following:
release;
delete;
leave; and
not spam.

3. The enterprise email manager of claim 1 further operable to:
receive a selection of one of the user-managed actions associated with the first email; and
process the first email based, at least in part, on the received selection.

4. The enterprise email manager of claim 3 further operable to generate a user parameter based on the received selection.

5. The enterprise email manager of claim 4 further operable to:
receive a second email to one or more expected recipients, the second email being substantially similar to the first email;
compare the user parameter to the one or more expected recipients of the second email; and
at least partially in response to the user parameter being associated with a particular one of the expected recipients of the second email, communicate the second email to the particular recipient.

6. The enterprise email manager of claim 3, the received selection comprising a Hyper Text Markup Language (HTML) request.

7. The enterprise email manager of claim 1 further operable to:
receive a second email to one or more expected recipients, the particular one of the expected recipients from the first email being one of the expected recipients from the second email;
identify the second email as an adverse email based, at least in part, on at least one of the plurality of enterprise parameters;
quarantine the second email; and
wherein the manager operable to generate the report email comprises manager operable to generate the report email based, at least in part, on the first and second emails, the information comprising first information identifying the first email, the report email further comprising second information identifying the second email and the report email further operable to present dynamic user-managed actions associated with the second email.

8. The enterprise email manager of claim 7 further operable to communicate the generated report email to the particular one of the expected recipients based on predetermined criteria.

9. The enterprise email manager of claim 8, the predetermined criteria selected from the group consisting of:
a predetermined time;
in response to a request from the particular one of the expected recipients;
upon receipt of a number of emails for the particular one of the expected recipients; or
a number of quarantined emails for the particular one of the expected recipients.

10. The enterprise email manager of claim 1, the report email further operable to present global actions associated with the first and second emails.

11. The enterprise email manager of claim 1, the report email comprising a plain text email associated with an HTML attachment.

12. The enterprise email manager of claim 1 further operable to:
compare the first email to at least one user parameter; and
generate and communicate the report email at least partially in response to the comparison.

13. The enterprise email manager of claim 1, at least a subset of the plurality of enterprise parameters comprising an enterprise-wide policy.

14. The enterprise email manager of claim 1 comprising:
a plurality of scanning engines, each scanning engine operable to:
receive the first email; and
identify the first email as an adverse email; and
a quarantine manager operable to:
receive the identified email from one of the scanning engines;
quarantine the email in a quarantine repository;
generate the report email; and
communicate the report email to the particular one of the expected recipients.

15. A method for managing emails in an enterprise comprising:
receiving a first email to one or more expected recipients;
identifying the first email as an adverse email based, at least in part, on one or more of a plurality of enterprise parameters;
quarantining the first email;
generating a report email based on the first email, the report email comprising information identifying the first email and the report email operable to present dynamic user-managed actions associated with the first email; and
communicating the report email to at least a particular one of the expected recipients.

16. The method of claim 15, the user-managed actions comprising at least one of the following:
release;
delete;
leave; and
not spam.

17. The method of claim 15 further comprising:
receiving a selection of one of the user-managed actions associated with the first email; and
processing the first email based, at least in part, on the received selection.

18. The method of claim 17 further operable to generate a user parameter based on the received selection.

19. The method of claim 17 further comprising:
receiving a second email to one or more expected recipients, the second email being substantially similar to the first email;
comparing the user parameter to the one or more expected recipients of the second email; and
at least partially in response to the user parameter being associated with a particular one of the expected recipients of the second email, communicating the second email to the particular recipient.

20. The method of claim 17, the received selection comprising a Hyper Text Markup Language (HTML) request.

21. The method of claim 15 further comprising:
receiving a second email to one or more expected recipients, the particular one of the expected recipients from the first email being one of the expected recipients from the second email;
identifying the second email as an adverse email based, at least in part, on at least one of the plurality of enterprise parameters;
quarantining the second email; and
wherein generating the report email comprises generating the report email based, at least in part, on the first and second emails, the information comprising first information identifying the first email, the report email further comprising second information identifying the second email and the report email further operable to present dynamic user-managed actions associated with the second email.

22. The method of claim 21 further comprising communicating the generated report email to the particular one of the expected recipients based on predetermined criteria.

23. The method of claim 22, the predetermined criteria selected from the group consisting of:
a predetermined time;
in response to a request from the particular one of the expected recipients;
upon receipt of a number of emails for the particular one of the expected recipients; or
a number of quarantined emails for the particular one of the expected recipients.

24. The method of claim 15, the report email further operable to present global actions associated with the first and second emails.

25. The method of claim 15, the report email comprising a plain text email associated with an HTML attachment.

26. The method of claim 15 further comprising:
comparing the first email to at least one user parameter; and
generating and communicating the report email at least partially in response to the comparison.

27. The method of claim 15, at least a subset of the plurality of enterprise parameters comprising an enterprise-wide policy.

28. A method for managing emails in an enterprise comprising:
receiving a first email at one of a plurality of scanning engine;
identifying the first email as an adverse email at the scanning engine;
receiving the identified email from one of the scanning engines at a quarantine manager;
quarantining the email in a quarantine repository;
generating a report email based on the first email, the report email comprising information identifying the first email and the report email operable to present dynamic user-managed actions associated with the first email; and
communicating the report email to at least a particular one of the expected recipients.

29. A server for managing emails in an enterprise comprising:
memory operable to store a plurality of enterprise parameters; and
one or more processors operable to:
receive a first email to one or more expected recipients;
identify the first email as an adverse email based, at least in part, on one or more of the plurality of enterprise parameters;
quarantine the first email in memory;
generate a report email based on the first email, the report email comprising information identifying the first email and the report email operable to present dynamic user-managed actions associated with the first email; and
communicate the report email to at least a particular one of the expected recipients.

30. The server of claim 29, the user-managed actions comprising at least one of the following:
release;
delete;
leave; and
not spam.

31. The server of claim 29, the one or more processors further operable to:
receive a selection of one of the user-managed actions associated with the first email; and
process the first email based, at least in part, on the received selection.

32. The server of claim 31, the one or more processors further operable to generate a user parameter based on the received selection.

33. The server of claim 31, the one or more processors further operable to:
receive a second email to one or more expected recipients, the second email being substantially similar to the first email;
compare the user parameter to the one or more expected recipients of the second email; and
at least partially in response to the user parameter being associated with a particular one of the expected recipients of the second email, communicate the second email to the particular recipient.

34. The server of claim 31, the received selection comprising a Hyper Text Markup Language (HTML) request.

35. The server of claim 29, the one or more processors further operable to:
receive a second email to one or more expected recipients, the particular one of the expected recipients from the first email being one of the expected recipients from the second email;
identify the second email as an adverse email based, at least in part, on at least one of the plurality of enterprise parameters;
quarantine the second email in memory; and
wherein the one or more processors operable to generate the report email comprises one or more processors operable to generate the report email based, at least in part, on the first and second emails, the information comprising first information identifying the first email, the report email further comprising second information identifying the second email and the report email further operable to present dynamic user-managed actions associated with the second email.

36. The server of claim 35, the one or more processors further operable to communicate the generated report email to the particular one of the expected recipients based on predetermined criteria.

37. The server of claim 36, the predetermined criteria selected from the group consisting of:
a predetermined time;
in response to a request from the particular one of the expected recipients;
upon receipt of a number of emails for the particular one of the expected recipients; or
a number of quarantined emails for the particular one of the expected recipients.

38. The server of claim 29, the report email further operable to present global actions associated with the first and second emails.

39. The server of claim 29, the report email comprising a plain text email associated with an HTML attachment.

40. The server of claim 29, the one or more processors further operable to:
compare the first email to a user parameter; and
generate and communicate the report email at least partially in response to the comparison.

41. The server of claim 29, at least a subset of the plurality of enterprise parameters comprising an enterprise-wide policy.

42. A system for managing emails in an enterprise comprising:
means for receiving a first email to one or more expected recipients;
means for identifying the first email as an adverse email based, at least in part, on one or more of a plurality of enterprise parameters;
means for quarantining the first email;
means for generating a report email based on the first email, the report email comprising information identifying the first email and the report email operable to present dynamic user-managed actions associated with the first email; and
means for communicating the report email to at least a particular one of the expected recipients.
